(19) United States
(12) Patent Application Publication
(10) Pub. No.: US 2017/0066607 A1
(43) Pub. Date: Mar. 9, 2017

(54) ENGAGED BIASED HOOK

(71) Applicant: MULTI-FAB PRODUCTS, LLC, Menomonee Falls, WI (US)

(72) Inventor: TIMOTHY J MUHL, Slinger, WI (US)

(73) Assignee: MULTI-FAB PRODUCTS, LLC, Menomonee Falls, WI (US)

(21) Appl. No.: 14/847,843

(22) Filed: Sep. 8, 2015

(51) Int. Cl. B65G 69/00

(52) U.S. Cl. CPC B65G 69/003

(57) ABSTRACT

Systems and methods relating to the restraining of a rear impact guard (“RIG”) attached to a vehicle or trailer with a hook and also with a hook as part of an impactable vehicle restraint. Contact between the hook and the RIG creates a reactant force that promotes rotation of the hook in the engaged direction, thereby further promoting positive engagement of the RIG by the hook.

### BACKGROUND OF THE INVENTION

This invention relates to restraining hooks for impactable vehicle rotating hook style vehicle restraints for use at loading docks. Impactable, rotating hook style vehicle restraints are used as a safety precaution to keep a parked vehicle from prematurely departing loading docks. Rotating hook impactable vehicle restraints use a rotating hook to engage, and restrain, a vehicle trailer.

An impactable vehicle restraint is moved into an operable position by the energy of the vehicle backing up to the loading dock and contacting the vehicle restraint which in turn moves it into position. Once the trailer is in position, a loading dock attendant engages the restraint which in turn rotates the restraining hook such that the hook engages the rear impact guard, or RIG, of the trailer. Once engaged the hook prevents the RIG and therefore the trailer from being removed from the loading dock until properly released by the dock attendant.

If a trailer is removed prematurely from a loading dock, it can still have a fork truck and operator in it, or worse, the trailer is removed when the fork truck is over the loading dock to trailer transition which can cause the fork truck and operator to fall to the approach resulting in significant damage to persons and property.

The restraining hook in these vehicle restraints are generally operated via electromechanical means, usually an electric motor coupled to a shaft rotational speed reducer such as a gear based drive train and or sprockets and chain. Included in the drivetrain is usually a clutch or brake to allow for slip to prevent damage to the drivetrain when the restraining hook is pulled by a RIG. While the hook is in the engaged position, it still allows for some limited horizontal motion of the RIG and trailer. It is not until the RIG is moved sufficiently away from the loading dock that the restraining hook captures the RIG and prevents further horizontal motion. This horizontal motion can occur for a number of reasons including the momentum transfer of the fork truck stopping and starting in the trailer, especially if the brakes of the trailer have not been properly set, or the truck driver attempting to drive away prematurely.

When the RIG is at its furthest point away from the loading dock and being captured by the hook, the hook has been pulled and rotated by the RIG so that it is in its most forward and lowest position in which it can reliably capture the RIG. Lowering the hook any further would put it in a condition that may not reliably capture the RIG.

Throughout the loading and or unloading process the trailer is subjected to up and down accelerations due to the combination of entry and exit of the relatively heavy fork truck into and out of the trailer and the compliance of the trailer suspension that allows this vertical motion. These up and down accelerations cause the restraint to move up and down with the trailer. The restraining hook, which pivots about an axis orthogonal to the vertical motion and is generally made from relatively thick, heavy steel, is also subject to inertial accelerations from the vertical motion of the restraint via the trailer. If the engagement system for the hook is not robust enough to hold against the combination of trailer accelerations and acceleration downward due to gravity, the resulting torque on the hook pivot axis can rotate it towards the disengaged position, even to the point of no longer being safely engaged. In cases where the hook has already been pulled to its lowest reliable capture point and further loading or unloading is required, any further lowering of the hook due vertical motion can cause an unsafe situation.

At least one prior art device incorporates a position sensor to monitor the position of the hook and to reenergize the system to bring the hook back to the maximum engaged position if it was determined that the hook was too low. However, this system requires that the hook already be in a low position before action is taken to place the hook back into a safe position.

Another prior art device uses a power mode that continuously supplies power to the motor of the system to quickly return the hook to the engaged position if the hook becomes briefly disengaged. However, this system requires the motor to be continuously running and therefore is continuously using electricity, and if a power shortage was experienced, the hook would fail and disengage.

Accordingly, the art of RIG restraint could benefit from a device capable of reducing the likelihood of further rotation in the disengaging direction when a situation occurs that positions the hook at its absolute lowest point of capturing a RIG.

### SUMMARY OF THE INVENTION

The present invention relates to a rear impact guard (“RIG”) restraint device, and more particularly to a hook capable of reducing the likelihood of further rotation in the disengaging direction when at its lowest point of capturing a RIG.

One aspect of the present invention provides a restraining hook for impactable vehicle restraints for restraining a rear impact guard of a vehicle, wherein the hook has a first hook surface, a second hook surface opposite the first hook surface, a shank with a shank first portion, a shank top side, and a shaft bore positioned in the shank first portion extending from the first hook surface through the second hook surface; a point with a tooth; a bend extending between the shank and the point, the bend having a bend internal side adjoining the shank top side with a substantially planar section adjoining the point; and the substantially planar section configured to make contact with the rear impact guard and generating a resultant force normal to the substantially planar section, the resultant force defines a reaction force line which extends from the point of contact, below the shaft bore.

Additionally, a gap may be defined between the tooth and the rear impact guard when the hook is engaged with the rear impact guard.

Another aspect of the invention provides an impactable vehicle restraint for retaining a rear impact guard of a vehicle, whereby the restraint includes a vertical member with a track; a carriage with a horizontal carriage rear impact guard riding surface and a slot, with the carriage slidably engaged with the track of the vertical member; a hook with a first hook surface; a second hook surface opposite the first hook surface; a shank with a shank first portion, a shank top side, and a shaft bore positioned in the shank first portion extending from the first hook surface through the second hook surface; a point having a tooth; and a bend extending between the shank and the point. The bend has a bend internal side adjoining the shank top side and a substantially planar section adjoining the point. Whereby the hook is rotabable relative to the carriage about the shaft bore in an engaging direction and a disengaging direction.

Further, the substantially planar section may be configured to make contact with the rear impact guard thereby generating a resultant force normal to the substantially planar section, the resultant force defining a reaction force line which extends from the point of contact, below the shaft bore; whereby the orientation of the resultant force creates a resultant torque about the shaft bore in the engaging direction.

Additionally or alternatively, when the hook of the restraint is engaged with the rear impact guard, a gap is defined between the tooth and the rear impact guard.

The gap may close upon the carriage experiences vertical movement along the track of the vertical member causing the hook to rotate in the disengaging direction; the tooth is configured to make contact with the rear impact guard.

A further aspect of the invention provides a method of restraining a rear impact guard of a vehicle, including the steps of: selecting an impactable vehicle restraint comprising a vertical member with a track,

a carriage with a horizontal carriage rear impact guard riding surface and a slot, the carriage slidably engaged with the track of the vertical member, a hook with a first hook surface, a second hook surface opposite the first hook surface, a shank having a shank first portion, a shank top side, and a shaft bore positioned in the shank first portion extending from the first hook surface through the second hook surface, a point having a tooth, and a bend extending between the shank and the point, the bend has a bend internal side adjoining the shank top side and a substantially planar section adjoining the point; providing the hook in a first, stored, position wherein the hook is substantially positioned within the slot of the carriage; receiving the rear impact guard along the horizontal carriage rear impact guard riding surface beyond the point, and above the shank, of the hook; rotating the hook out of the slot about the shaft bore to a second, engaging, position; receiving the rear impact guard within the bend of the hook, placing the hook in a third, engaged, position, wherein the rear impact guard is in contact with the substantially planar section; whereby the contact between the rear impact guard and the substantially planar section creates a resultant force normal to the substantially planar section, the resultant force defines a reaction force line which extends from the point of contact to below the shaft bore; and whereby the orientation of the resultant force creates a resultant torque about the shaft bore in the direction of the engaging position.

When in the engaging position, the point and substantially the entire bend are outside of the slot of the carriage, and a portion of the shank top side is outside of the slot above the horizontal carriage rear impact guard riding surface.

When the rear impact guard is being received within the bend, the rear impact guard contacts the shank top side and rotates the hook in the direction of the stored position.

When the hook is in the engaged position a gap is defined between the tooth and the rear impact guard.

The method may include the step of contacting the rear impact guard with the tooth in the event the carriage experiences vertical movement along the track of the vertical member which causes the hook to rotate in the disengaging direction.

### BRIEF DESCRIPTION OF THE DRAWINGS

FIG. 1 is a side view of a hook according to the present invention.

FIG. 2 is a perspective view of a vehicle restraint with the hook shown in FIG. 1.

FIG. 3A is a side view of a restraint carriage with the hook illustrated in FIG. 2 in a first position.

FIG. 3B is a side view of the restraint carriage and the hook illustrated in FIG. 3A in a second position.

FIG. 3C is a side view of the restraint carriage and the hook illustrated in FIG. 3A in a third position.

FIG. 4A is a side view of a restraint carriage with a prior art hook in a first position.

FIG. 4B is a side view of the restraint carriage and prior art hook shown in FIG. 4A in a second position.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

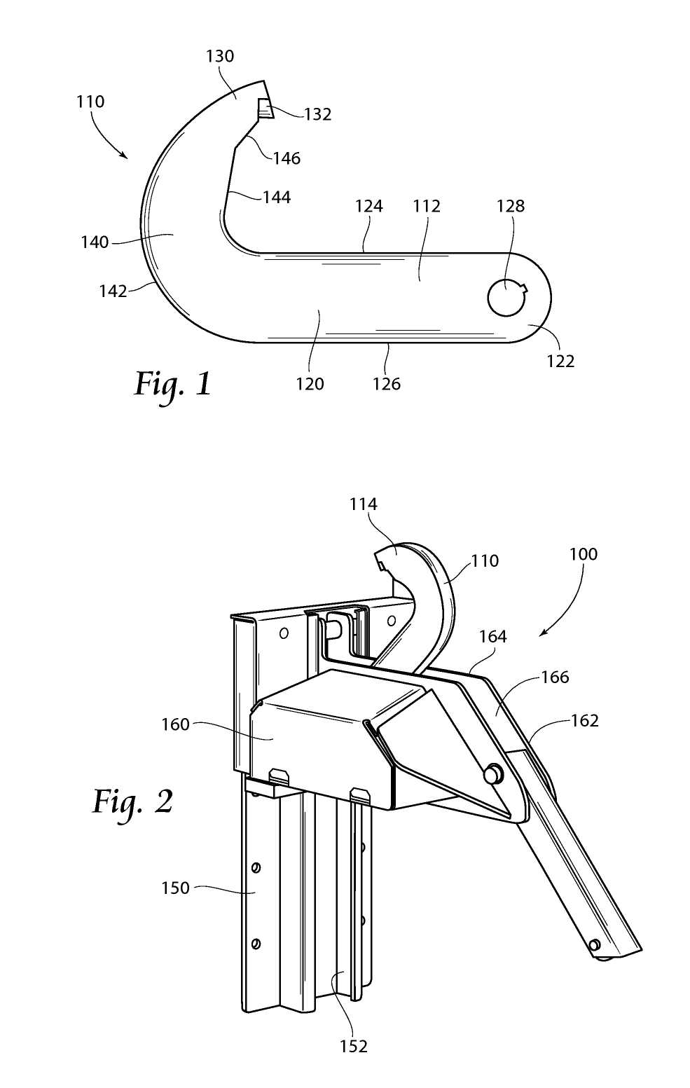

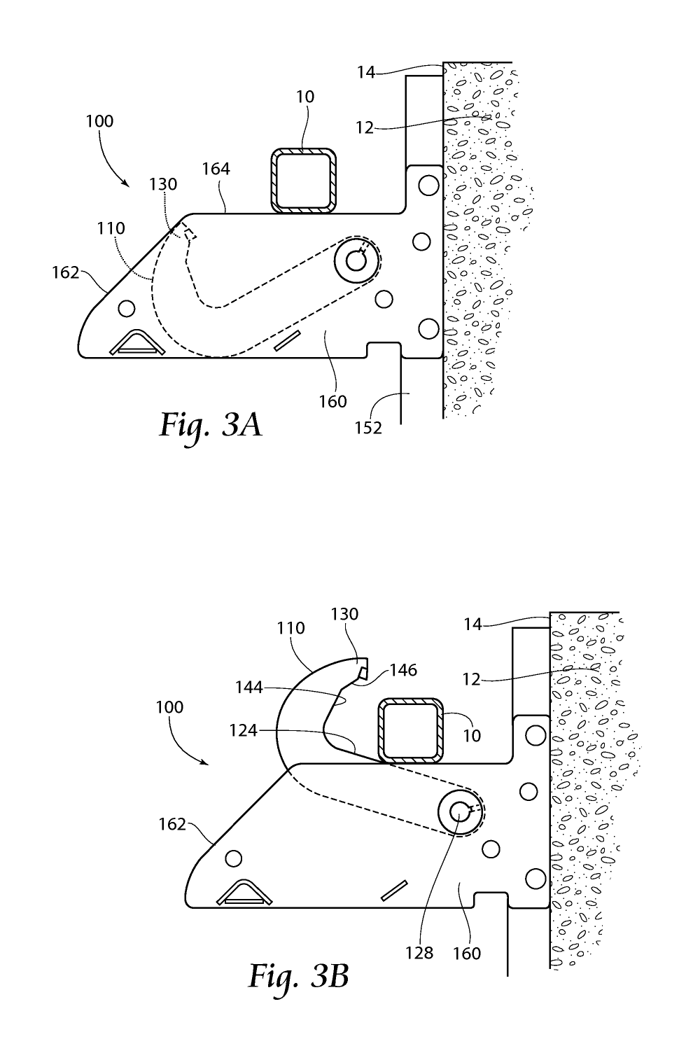

FIG. 1 shows an exemplary embodiment of a hook 110 according to the present invention for engaging with a rear impact guard (hereinafter “RIG”) of a trailer. The hook 110 comprises a shank 120, a point 132, and a bend 140 extending between the shank 120 and the point 132. The hook 110 has a first hook surface 112 and a second hook surface 114 (FIG. 2) opposite and substantially parallel with the first hook surface 112.

The shank 120 extends from a shank first end portion 122 to the bend 140. The shank 120 comprises a shank top side 124 opposite a shank bottom side 126 and has a shaft bore 128 located in the shank first end portion 122 extending from the first hook surface 112 through the second hook surface 114.

The bend 140 has a bend external side 142 continuing from the shank bottom side 126 and a bend internal side 144 continuing from the shank top side 124. The bend internal side 144 preferably has a substantially planar section 146 at or near the point 130.

The point 130 preferably comprises a tooth 132 proximate to the substantially planar section 146 of the bend internal side 144.

An exemplary embodiment of an impactable vehicle restraint 100 is shown in FIG. 2. The impactable vehicle restraint 100 preferably has at least one vertical member 150 with a track 152, a carriage 160 that rides along the track 152, and the hook 110 pivotably attached to the carriage 160. The vertical member 150 is mountable to the face 14 of a loading dock 12.

The carriage 160 preferably has a plurality of carriage RIG riding surfaces preferably including a sloped portion 162 and a generally horizontal portion 164, and a slot 166 extending inward from the carriage RIG riding surfaces 162, 164 in which the hook 110 preferably resides when not in use and is pivotable outward therefrom when in use.

Additionally or alternatively, the carriage 160 is biased upwards by a biasing mechanism (not shown), for example one or more springs.

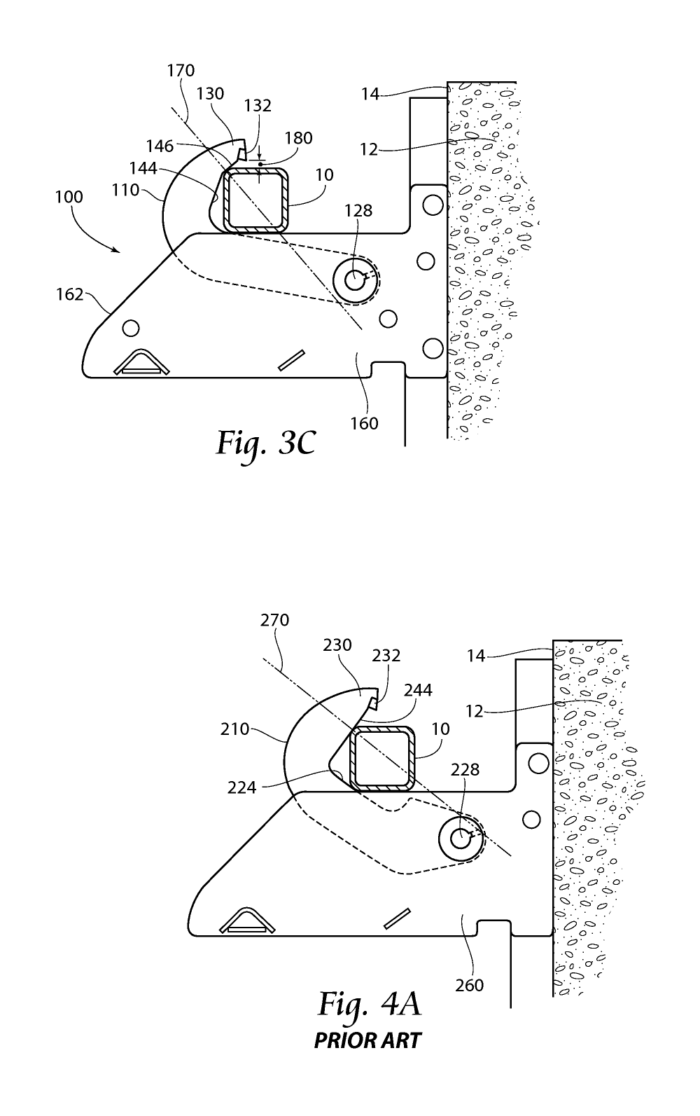

Looking to FIGS. 3A-3C, the impactable vehicle restraint 100 is shown in use as it interacts with a rear impact guard, or RIG 10, of a trailer (not shown). As illustrated in FIG. 3A, the hook 110 is in a first, or stored, position within the slot 166 (FIG. 2). As a trailer (not shown) approaches a loading dock the RIG 10 engages the carriage 160 at the sloped portion carriage RIG riding surface portion 162 and pushes the carriage 160 into position by continuing to back up the trailer. The RIG 10 of the trailer slides along the carriage RIG riding surfaces 162, 164 until the RIG 10 is in beyond the point 130 of the hook 110 and the trailer is parked firmly against dock bumpers (not shown). An operator (not shown) then activates the hook 110 by an electro-mechanical means or any other means known in the art to rotate the hook 110 out of the slot 166 to a second, or engaging, position (FIG. 3B). At this point any horizontal motion of RIG 10 towards the bend internal side 144 and away from the face 14 of the loading dock 12 will rotate the hook 110 towards the first, stored position because of the RIG's 10 contact with the shank top side 124, and thereby putting the vehicle restraint 100 into a third, or engaged, position wherein the RIG 10 makes contact with substantially planar section 146 of the bend internal side 144 (FIG. 3C).

As shown in FIG. 3C, the vehicle restraint 100 is shown with the hook 110 in the engaged position with the RIG 10 in contact with the substantially planar section 146 of the bend internal side 144, with a gap 180 between the RIG 10 and the tooth 132 of the point 130. Any resultant force resulting from the contact between the RIG 10 and the hook 110 acts normal to the substantially planar section 146 of the bend internal side 144 as indicated by a reaction force line 170. The reaction force line 170 extends below the hook shaft bore 128, around which the hook 110 rotates and thereby provides a resultant torque on the hook 110 in the engaging position direction or, as oriented in FIG. 3C, a clockwise direction.

The orientation of the reaction force line 170 below the hook shaft bore 128 provided by the substantially planar section's 146 configuration and reaction with the RIG 10, encourages a torque to be applied to the hook 110 in the engaging position direction when horizontal motion of the RIG 10 away from the face 14 of the loading dock 12 is experienced. The resultant torque on the hook 110 encourages the maintenance of the gap 180. At this point the RIG 10 cannot move further away from the face 14 of the loading dock 12 and is fully captured by the hook 110.

During loading or unloading of the trailer (not shown), the RIG 10 may experience vertical accelerations of the carriage 160 along the track 152. The vertical accelerations may cause the hook 110 to rotate in the stored position direction. The gap 180 provides a margin of safety against disengagement of the hook 110 from the RIG 10 in these situations as the tooth 132 will make contact with, and retain, the RIG 10.

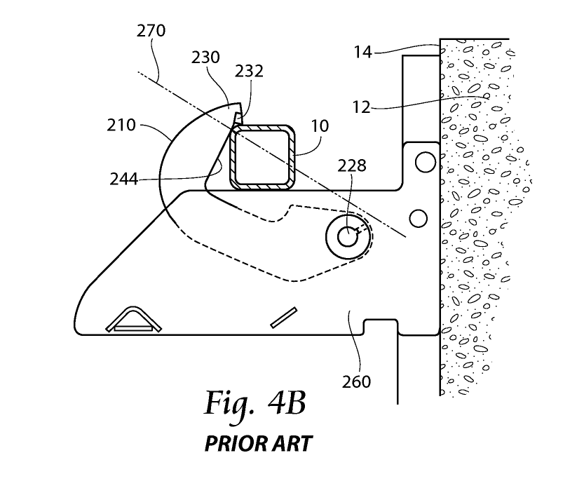

Referring to FIG. 4A for comparison with the prior art hook 210, RIG 10 is in an intermediate horizontal location with prior art hook 210 in the second, engaging position. The RIG 10 contacts prior art hook 210 on either or both of the shank top side 224 and the bend internal side 244 of the prior art hook 210 and further horizontal movement of the RIG 10 away from the face 14 of the loading dock 12 will position the prior art hook 210 in the third, engaged position (FIG. 4B) with the tooth 232 of the point 230 engaged with the RIG 10 at the capture limit state.

With regards to FIG. 4B, the RIG 10 is in contact with the tooth 232 of the prior art hook 210 and can no longer move further away from the face 14 of the loading dock 12, and the RIG 10 is in contact the tooth 232 and also with the bend internal side 244 which results in a force normal to the bend internal side 244 as indicated by the prior art hook reaction force line 270.

The prior art hook reaction force line 270 is oriented above the prior art hook shaft bore 228, around which the prior art hook 210 rotates, and provides a resultant torque on the prior art hook 210 in the stored position direction, or counterclockwise direction according to the orientation of the prior art hook 210 in FIG. 4A, because it extends above the hook shaft bore 228 of the prior art hook 210.

In the engaged position, the prior art hook 210 is at its absolute lowest point (i.e., the capture limit) of reliably capturing the RIG 10. Any vertical movement of the carriage 260 during loading or unloading may result in the prior art hook 210 rotating away from the RIG 10 in the stored position direction and disengaging the prior art hook 210 from the RIG 10, creating a potentially unsafe condition.

The torque applied to the prior art hook 210 by the RIG 10 when in the engaged position will not maintain engagement because the torque is applied in the counter-clockwise, stored position direction, due to the prior art reaction force line 270 extending above the shaft bore 228.

On the other hand, the hook 110 of the present invention (see FIG. 3C) experiences a torque applied in the clockwise, engaged direction because the orientation and interaction of the substantially planar surface 146 of the bend internal side 144 and the RIG 10 results in the reaction force line 170 extending below the shaft bore 128.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A restraining hook for impactable vehicle restraints for restraining a rear impact guard of a vehicle or trailer, the hook comprising:
a first hook surface;
a second hook surface opposite the first hook surface;
a shank having a shank first portion, a shank top side, and a shaft bore positioned in the shank first portion extending from the first hook surface through the second hook surface;
a point having a tooth;
a bend extending between the shank and the point, the bend having a bend internal side adjoining the shank top side with a substantially planar section adjoining the point; and
the substantially planar section configured to make contact with the rear impact guard and generating a resultant force normal to the substantially planar section, the resultant force defines a reaction force line which extends from the point of contact, below the shaft bore.

2. The hook according to claim 1, wherein when the hook is engaged with the rear impact guard, a gap is defined between the tooth and the rear impact guard.

3. An impactable vehicle restraint for retaining a rear impact guard of a vehicle, the restraint comprising:
a vertical member with a track;
a carriage with a horizontal carriage rear impact guard riding surface and a slot, the carriage slidably engaged with the track of the vertical member;
a hook having a first hook surface; a second hook surface opposite the first hook surface; a shank having a shank first portion, a shank top side, and a shaft bore positioned in the shank first portion extending from the first hook surface through the second hook surface; a point having a tooth; and a bend extending between the shank and the point, the bend having a bend internal side adjoining the shank top side and a substantially planar section adjoining the point;
whereby the hook is rotabable relative to the carriage about the shaft bore in an engaging direction and a disengaging direction;
the substantially planar section configured to make contact with the rear impact guard and generating a resultant force normal to the substantially planar section, the resultant force defines a reaction force line which extends from the point of contact, below the shaft bore; and
whereby the orientation of the resultant force creates a resultant torque about the shaft bore in the engaging direction.

4. The restraint according to claim 3, wherein when the hook is engaged with the rear impact guard, a gap is defined between the tooth and the rear impact guard.

5. The restraint according to claim 4, wherein if the carriage experiences vertical movement along the track of the vertical member causing the hook to rotate in the disengaging direction, the gap is closed and the tooth is configured to make contact with the rear impact guard.

6. A method of restraining a rear impact guard of a vehicle or trailer, the method comprising the steps of:
selecting an impactable vehicle restraint comprising:
a vertical member with a track;
a carriage with a horizontal carriage rear impact guard riding surface and a slot, the carriage slidably engaged with the track of the vertical member;
a hook having a first hook surface; a second hook surface opposite the first hook surface; a shank having a shank first portion, a shank top side, and a shaft bore positioned in the shank first portion extending from the first hook surface through the second hook surface; a point having a tooth; and a bend extending between the shank and the point, the bend having a bend internal side adjoining the shank top side and a substantially planar section adjoining the point;
providing the hook in a first, stored, position wherein the hook is substantially positioned within the slot of the carriage;
receiving the rear impact guard along the horizontal carriage rear impact guard riding surface beyond the point, and above the shank, of the hook;
rotating the hook out of the slot about the shaft bore to a second, engaging, position;
receiving the rear impact guard within the bend of the hook, placing the hook in a third, engaged, position, wherein the rear impact guard is in contact with the substantially planar section;
whereby the contact between the rear impact guard and the substantially planar section creates a resultant force normal to the substantially planar section, the resultant force defines a reaction force line which extends from the point of contact to below the shaft bore; and
whereby the orientation of the resultant force creates a resultant torque about the shaft bore in the direction of the engaging position.

7. The method of restraining a rear impact guard according to claim 6, whereby when in the engaging position, the point and substantially the entire bend are outside of the slot of the carriage, and a portion of the shank top side is outside of the slot above the horizontal carriage rear impact guard riding surface.

8. The method of restraining a rear impact guard according to claim 6, whereby when the rear impact guard is being received within the bend, the rear impact guard contacts the shank top side and rotates the hook in the direction of the stored position.

9. The method of restraining a rear impact guard according to claim 6, wherein when the hook is in the engaged position, a gap is defined between the tooth and the rear impact guard.

10. The method of restraining a rear impact guard according to claim 6, further comprising the step of contacting the rear impact guard with the tooth in the event the carriage experiences vertical movement along the track of the vertical member which causes the hook to rotate in the disengaging direction.
